(19) United States
(12) Patent Application Publication
(10) Pub. No.: US 2007/0089931 A1
(43) Pub. Date: Apr. 26, 2007

(54) Hunting Stand Tray

(76) Inventor: William Hunt, Weston, WV (US)

Correspondence Address: DINSMORE & SHOHL LLP, 900 LEE STREET, SUITE 600, CHARLESTON, WV, 25301, US

(21) Appl. No.: 11/163,541

(22) Filed: Oct. 21, 2005

(51) Int. Cl. E06C 5/32

(52) U.S. Cl. 182/129

(57) ABSTRACT

A tray mountable on a hunting stand having rails, comprised of a body having a generally planar support surface extending parallel to the floor of the stand, one or more side surfaces relatively perpendicular to said support surface, and mounting sections configured to mount the tray on at least one rail of the hunting stand. The tray may optionally have cup holder detents, hooks, intermediate walls and recess to receive the barrel of a firearm. The tray may be manufactured as a single piece, or in multiple, interchangeable sections.

The present invention relates to providing trays on elevated stands used in the sport of hunting, where such trays may be useful in the management of hunting accessories.

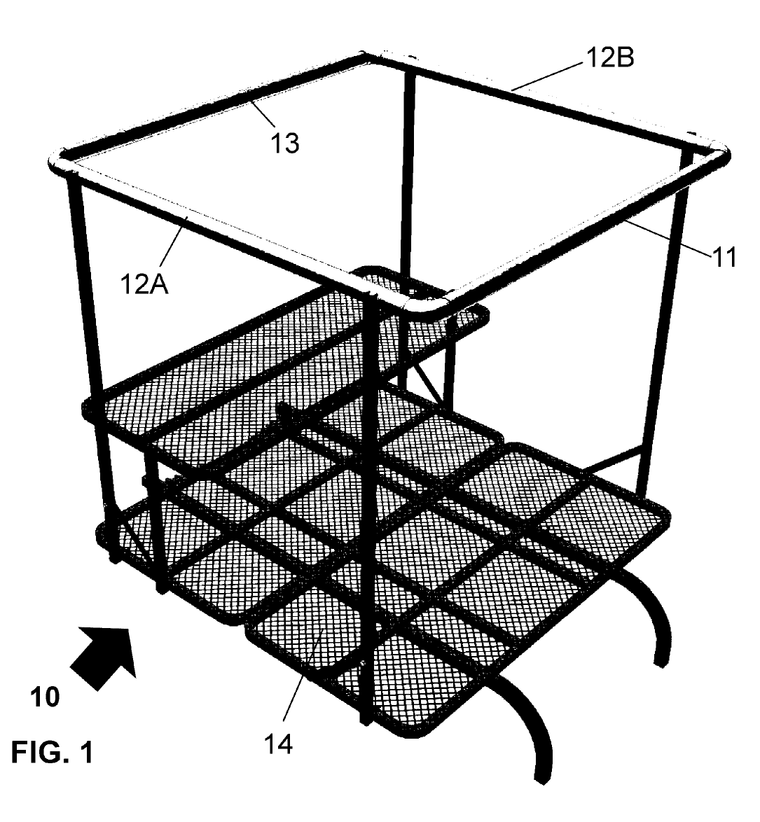

In the sport of hunting, a commonly used strategy is for the hunter to secure a position to observe prey, while remaining concealed and unnoticed. Many types of shelters, blinds and/or camouflages are used for this purpose. A particularly useful device employed by a hunter is the tree or elevated stand, which permits the hunter to be concealed as well as relatively comfortable for long periods of time. An example of a tree stand is depicted in FIG. 1. StrongBuilt, Inc. of Waterproof, Louisiana, sells a typical model hunter's ladder stand under the mark Magnum Ladder Stand. In addition to a non-reflective paint finish, this ladder stand is equipped with 3 ladder sections (providing a tree stand height of 15 feet), a platform, a shooting rail, and a seat with a camouflaged seat cushion, which easily accommodates two adults. The shooting rail has a padded cover to protect the railing from being accidentally hit by a hard object and making a noise. Such a noise could reveal the location of the hunter.

The function of camouflage in hunting is also well established. Even though a tree stand is positioned above the sight line of most game animals and may have a non-reflective paint finish (ordinarily black, olive drab, or gray), the hunter may take additional precautions to conceal himself. One example of such a precaution is the use of a camouflaged tree stand skirt. The tree stand skirt attaches to the rail and the platform of the tree stand creating a concealment zone, thereby allowing the hunter to move within the zone while remaining undetected by prey.

Hunting supplies that are typically carried by a hunter include, for example, food, drinks, binoculars, a radio, a grunt call, rattling antlers, firearms, ammunition, and a flashlight. Upon reaching his location, the hunter requires a means to store and manage these items so that they are easily accessible at a moment's notice, without requiring substantial movement or causing any sound that may be audible to prey.

While pant pockets and backpacks provide adequate storage for carrying items to the hunting location, both have limitations for managing items while in the tree stand. Pant pockets are limited in size and capacity, and can be cumbersome to retrieve items from. A backpack is awkward to access while in a seated position and items are typically unmanaged and difficult to find within it; furthermore, the opening and closing of backpack zippers causes unnecessary noise that could easily result in the hunter being detected. Items can be removed from pockets and backpacks upon arriving to the tree stand, but current methods of storing and managing items on the tree stand seat or around the neck of the hunter is not optimal. When items are stored in a haphazard manner, out of convenient reach of the hunter, they can hinder rather than aid the hunter's sport.

There are presently many products on the market that are useful to a hunter for storing and managing hunting accessories while hunting out of a tree stand. For example, API Outdoors, Inc. of Tallulah, LA sells a Triple Hook Gear Hanger, a Treestand Accessory Belt and Bow, Gun & Gear Holders, all of which mount to the tree on which the tree stand is perched. If the hunter has taken the added precaution of using a tree stand with a skirt to prevent detection, he does not want to move outside the concealment zone created by the skirt; however, with these products the hunter has to turn around and raise his arm to reach above his head to retrieve his gear (causing movement outside of the concealment zone). This amount of movement may result in the hunter being detected by the prey.

Finally, while trays themselves have long been utilized in other fields of art to store and manage supplies, the applicant believes that the hunting industry has not fully appreciated the need for them and their utility and advantages when used in connection with hunting stands.

Therefore, there is a need in the art for accessories to assist the hunter in organizing and accessing his equipment and supplies while utilizing an elevated stand, without requiring substantial movement from his seated position or perceptible noise. An object of the present invention is to provide a gear manager for a hunter that may be removably affixed to a hunting tree stand or other elevated stand. An additional object of the present invention is to provide a gear manager that is easily accessible to the hunter while he or she is seated in the tree or elevated stand, without requiring noticeable movement or noise.

Another object of the present invention is to provide a gear management system that is not visually noticeable in use. Another object of the present invention is to provide a gear management system that may be disassembled for easy packing for transportation to and from the tree stand. These and other objects of the invention will be apparent through the disclosure and claims, which follow.

The invention disclosed by means of a plurality of embodiments described in this specification and in the drawings provides a tray or shelf that may be affixed to or otherwise integrated with the railing of a hunter's stand. The storage areas, tray, gear hooks and recesses of embodiments of the invention (all as hereinafter described) furnish a convenient and spacious place to store items needed by the hunter during his extended wait for prey. Embodiments of the present invention may be manufactured from non-reflective, high-density polyethylene or other materials, and may be water resistant or weatherproof.

The gear manager system of some embodiments of the present invention may be hung from one or more railings of a hunting tree stand or other elevated stand, so that the system may be concealed by a tree stand skirt. Furthermore, some embodiments of the present invention may be disassembled for easy packing for transportation to and from the tree stand.

Certain embodiments disclosed within are economical, easy to manufacture, and advantageously utilized in the field. There are other aspects of the present invention and the various disclosed embodiments that will become apparent as the specification proceeds.

The applicant's preferred embodiments are shown in the accompanying drawings wherein:

FIG. 1 is a perspective view of a two-person tree stand with which the present invention may be used;

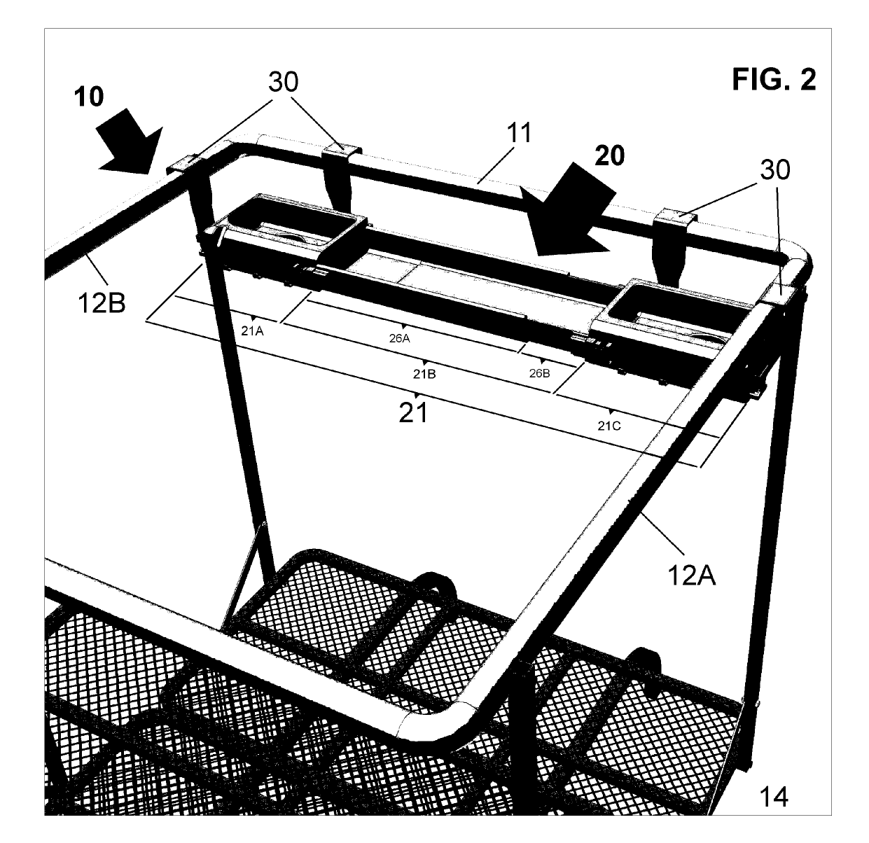

FIG. 2 is a view of one embodiment of a tray of the present invention, mounted on the front rail of the hunting stand shown in FIG. 1;

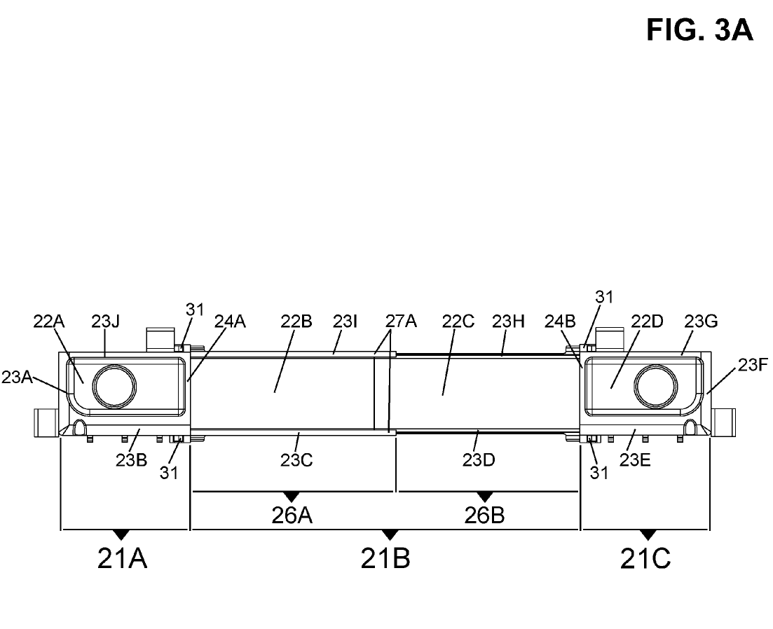

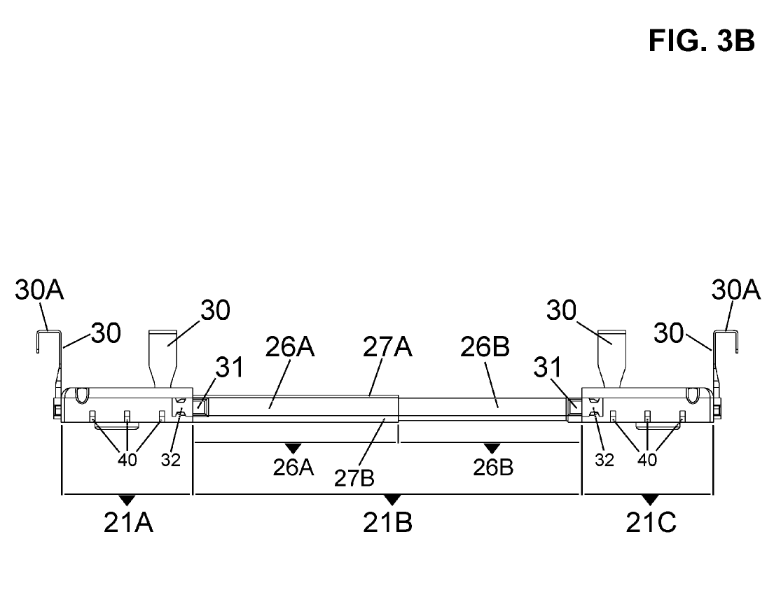

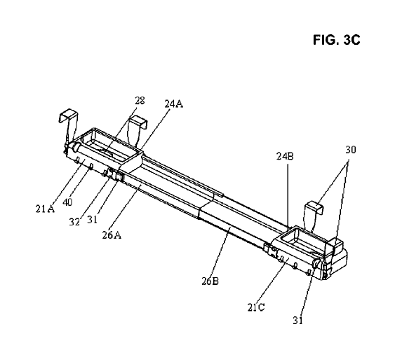

FIGS. 3A and 3B are views of the same embodiment of a tray as depicted in FIG. 2;

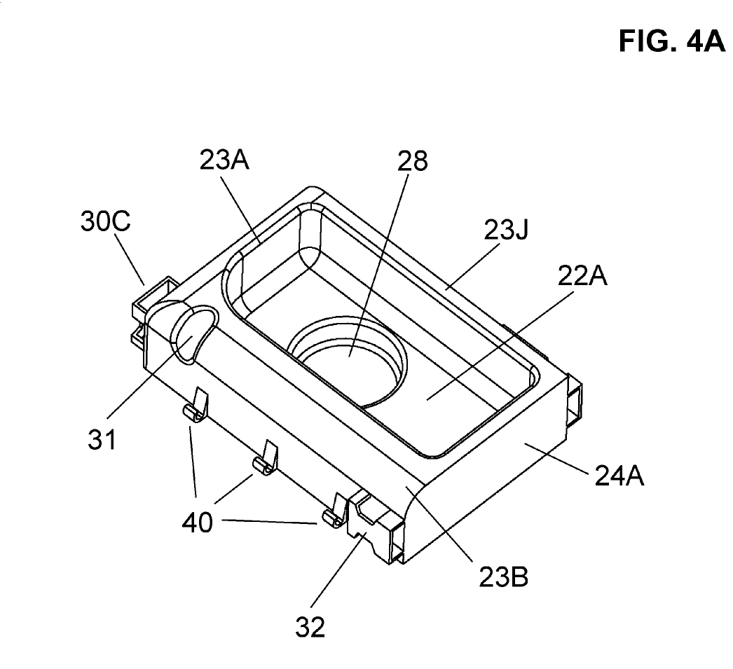

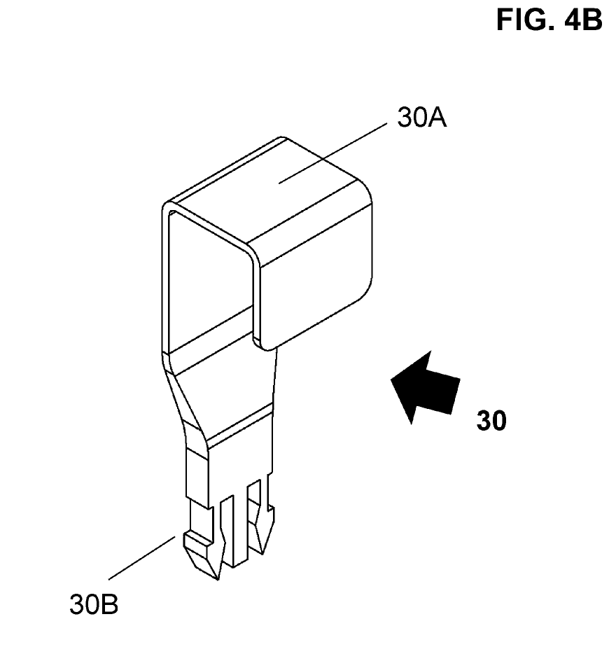

FIGS. 4A and 4B are views of some of the components of the embodiment of a tray as depicted in FIG. 2; and

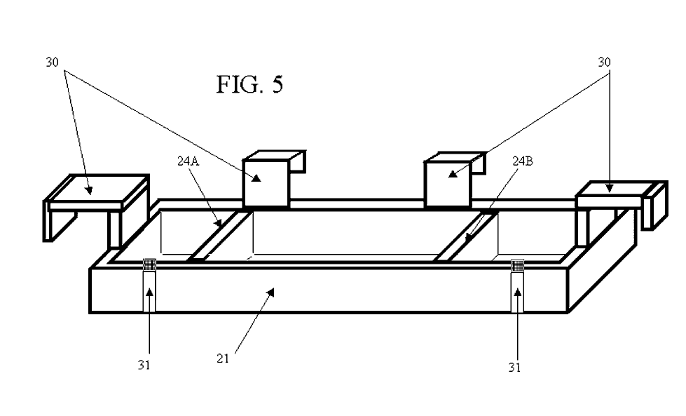

FIG. 5 is a view of another embodiment of the tray of the present invention.

In the following detailed description of the preferred embodiments, reference is made to these drawings, which form a part of this specification. The drawings show, by way of illustration, specific embodiments. It is to be understood that other embodiments may be utilized and structural changes may be made without departing from the scope of the present invention.

With reference now to FIG. 1, the hunting stand 10 depicted therein comprises four upper rails; a front rail 11 (sometimes referred to as a shooting rail); two opposing side rails 12A and 12B extending from the front rail 11, a back rail 13, and a floor 14. A hunter (not shown) may sit or stand in the hunting stand 10, and may therefrom view game and participate in other hunting activities.

With reference to FIG. 2, the hunting stand 10 includes an embodiment of the tray 20 of the present invention removably mounted on the front rail 11 and the side rails 12A and 12B of the hunting stand 10. The embodiment of tray 20 shown in FIGS. 2, 3A and 3B comprises a body 21 having three sections 21A, 21B, and 21C, four generally planar support surfaces 22A, 22B, 22C and 22D extending parallel to the floor 14 of the stand 10, as well as exterior walls 23A, 23B, 23C, 23D, 23E, 23F, 23G, 23H, 23I and 23J, and interior walls 24A and 24B, which are generally perpendicular to said support surfaces 22A, 22B, 22C and 22D. The embodiment of tray 20 shown in FIG. 5 is similar to the embodiment shown in FIGS. 2, 3A and 3B, but has a single main section 24, with interior walls 24A and 24B to form the three subsections 21A, 21B and 21C of the body 21. Although the invention is shown as generally rectangular, it would be understood by one skilled in the art that the tray may be configured in a different shape; for example, an interior arc or an L- or U-shape. Furthermore, the body 21 of the present invention may include additional or no interior or exterior walls, more or less sections, and one or more planar support surfaces.

The interior walls 24A and 24B of the body 21 allow the hunter to organize and compartmentalize various items, and may further function to strengthen the support capabilities of the tray 20. The body 21 may optionally have, extending from the planar surface of the exterior walls 22B-E thereof, one or more hooks 40 for hanging various items.

As depicted in FIG. 4A, the tray 20 may further be configured with one or more recesses 31 on an exterior wall (shown as 23B in the figure) to rest the barrel of a firearm.

With continuing reference to FIGS. 2, 3A, 3B, and 5, and as depicted in FIG. 4A, any of the planar support surfaces 22A, 22B, 22C and 22D may also include a cup-holder detent 28 for purposes of allowing the body 21 to more securely support cups, bottles and jars.

In an embodiment of the present invention (as depicted in FIG. 5), the tray 20 is manufactured as a single unit. In another embodiment, (as depicted in FIGS. 2, 3A and 3B), the tray has multiple, removable, interlocking sections which allow a user to modify the tray 20 by interchanging sections, for purposes of shape or size, and to allow a user to replace a section, rather than the entire unit, in the event a section is fractured or a different design is desired. As an example, the middle section 21B of the body 21 may be offered in different lengths to accommodate varying rail lengths of hunting stands 10. Alternatively, the middle section 21B may comprise multiple, engaged subsections 26A and 26B as shown in FIGS. 2, 3A and 3B, allowing the hunter to adjust the length of the body 21 by sliding the subsections 26A and 26B closer together or further apart. These engaged sections 26A and 26B may be designed so that one such section, shown as section 26A in FIGS. 3A and 3B, has lips 27A and 27B formed on the lateral edges of exterior sides 23C and 23I thereof, where said lips curve inward towards the longitudinal axis of the body 21 to respectively receive the exterior walls 23D and 23H of section 26B.

In multi-piece embodiments, the sections may be affixed or removably interconnected by fastener systems or other fastening means. As shown in FIGS. 2, 3A and 3B, the middle section 21B of the body 21 includes fasteners 31 affixed to or formed as a part of the ends of said section 21B, and the end sections 21A and 21C include receiving ports 32 positioned, sized and designed to receive the fasteners 31 when the tray 20 is assembled. As shown in FIG. 3, the fasteners may be affixed to or formed as part of the exterior walls 23C, 23D, 23H and 23I of the middle section 21B, and the receiving ports may be affixed to or formed as part of the exterior walls 23B, 23E, 23G and 23J of the end sections 21A and 21C. It would be understood by one skilled in the art that other fastener systems or means of removably connecting sections suitable for use in the present invention may be used to interconnect the sections 21A, 21B and 21C, that said fasteners 31 and receiving ports 32 may be located at other corresponding portions of said sections, and that the receiving ports 32 may be placed on the middle section 21B with the fasteners 31 correspondingly placed on the end sections 21A and 21C.

Affixed to the body 21 of the tray 20 as shown in FIGS. 2, 3A, 3B, and 5, are one or more mounting sections 30 configured and positioned on the body 21 to mount and secure the tray 20 on three rails 11, 12A and 12B of the hunting stand 10. As shown in FIG. 4B, the mounting sections 30 may be bent or squared at the top 30A to allow the said top portion 30A to receive a rail (and any padding thereon) of the hunting stand. Furthermore, the mounting sections 30 may be removably affixed to the body 21 by, for example, fastener 30B and receiving port 30C. It would be understood by one skilled in the art that the mounting sections may be configured and positioned on the body 21 to allow the tray 20 to mount on other types of rails of hunting stands and to any logical number of rails thereof. Furthermore, it would be understood by one skilled in the art that the structure and design of the mounting sections may vary based upon the structure of the hunting stand 10; for example, the rail may be modified to receive mounting brackets. Alternatively, the tray may be integrated with the rail. The applicant prefers to mount the tray 20 in the embodiments shown in the figures to three of the rails of the hunting stand 10, so that the tray 20 is more securely attached thereto.

The components of tray 20 are preferably made of molded plastic, such as polystyrene, making it lightweight, economical and easy to manufacture, relatively durable, rigid, and strong. The tray 20 or portions thereof may, however, be made of other or additional materials, including but not limited to wood, which can add further stability and rigidity to the tray.

In use, the hunter assembles the multi-section, expandable tray of an embodiment of the present invention by interconnecting the sections 21A, 21B and 21C thereof, affixing the mounting sections thereto and adjusting the length of the middle section 21B by engaging and adjusting subsections 26A and 26B, and mounts the same on the rails of a hunting stand by means of the mounting sections. He or she may then place on the tray, or hang on the hooks, his or her hunting supplies, for example food, drinks, binoculars, a radio, a grunt call, rattling antlers, ammunition and a flashlight, and may rest in a recess 31 his or her firearm.

What is claimed is:

1. A tray for mounting on a hunting stand, said hunting stand having one or more rails, comprising: a body, having a support surface, one or more side surfaces, and one or more mounting sections, whereby said mounting sections are configured to mount on at least one of said rails of said hunting stand.

2. The tray of claim 1, further comprising one or more tray walls perpendicular to said side surfaces and said support surface.

3. The tray of claim 1, wherein said support surface further comprises one or more cup-holder detents.

4. The tray of claim 1, further comprising a hook extending from the exterior planar surface of a said side surface.

5. The tray of claim 1, further comprising a recess formed in the exterior planar surface of a side surface detent being suitable for receiving the barrel of a firearm.

6. A tray for mounting on a hunting stand, said hunting stand having one or more rails, comprising: a body having multiple sections, each of such sections having a support surface and one or more side surfaces, and each of such sections having fastening means to fasten said sections together; and one or more mounting sections, whereby said mounting sections are configured to mount on at least one of said rails of said hunting stand.

7. The tray of claim 5, wherein the fastening means comprises a plurality of fasteners and receiving ports correspondingly affixed to one or more of said sections.

8. The tray of claim 5, wherein at least one of said support surfaces of said sections further comprises a cup-holder detent.

9. The tray of claim 5, further comprising a detent formed in the exterior planar surface of a side surface detent being suitable for receiving the barrel of a firearm.

10. The tray of claim 5, further comprising one or more hooks extending from an exterior planar surface of a said side surface.
